(19) United States
(12) Patent Application Publication
(10) Pub. No.: US 2013/0038769 A1
(43) Pub. Date: Feb. 14, 2013

(54) Image Display Apparatus for a Digital Camera

(71) Applicant: Ding Xiaoping, Guangzhou (CN)

(72) Inventor: Ding Xiaoping, Guangzhou (CN)

(21) Appl. No.: 13/337,475

(22) Filed: Dec. 27, 2011

(30) Foreign Application Priority Data
Aug. 8, 2011 (CN) 201120284302.8

(51) Int. Cl. H04N 5/222

(52) U.S. Cl. 348/333.01; 348/E05.022

(57) ABSTRACT

Provided herein are image display apparatuses for a digital camera that comprise a rotatable image display screen external to the digital camera rotatably hinged to a stabilizing frame effective to secure and stabilize the digital camera thereon. The image display screen is hinged to the stabilizing frame and pivots 180 degrees horizontally and rotates vertically 180 degrees forwardly and 90 degrees rearwardly. The stabilizing frame has a camera stabilizing portion to which the digital camera is secured and an image display screen receiving portion into which the image display screen can pivot for compact storage and easy transport. Also provided is an image display system that comprises the image display apparatus and a digital camera and, optionally, a tripod, engaged to the camera engagement portion of the stabilizing frame of the image display apparatus.

### CROSS-REFERENCE TO RELATED APPLICATIONS

This non-provisional application claims benefit of priority under 35 U.S.C. §119(a) of pending Chinese Patent Application No. 201120284302.8, filed Aug. 8, 2011, the entirety of which is hereby incorporated by reference.

### BACKGROUND OF THE INVENTION

1. Field of the Invention

The present invention relates generally to the fields of photography and digital cameras. More specifically, the present invention relates to an external rotatable image display apparatus that can be used with digital cameras and is especially suitable for use with tripods.

2. Description of the Related Art

A conventional digital camera usually contains an unrotatable display screen, which is integrated as part of the camera body. The nonrotatable display screens of conventional digital cameras make it inconvenient for shooting and viewing photos from different angles, such as shooting from beneath, from above and for a self-portrait. Oftentimes, the photographer must use an external device, such as an angle finder, to shoot and view photos from different angles.

A limited number of digital cameras comprise rotatable screens that can rotate within a certain angle along the internal rotation axis of the cameras. For example, Chinese Patent No 200920096549.X teaches a rotatable screen that can rotate within a 180 degree angle, making self-portrait possible. However, since the integrated display screen is limited by the dimension of the camera body, it is too small to provide sufficient visual details, thus limiting its utility in shooting photographs and for visual examination of the photographs.

With the recent widespread employment of high-resolution digital cameras, the integrated camera display screens increasingly reveal deficiencies in high-resolution photography and replay. Photographers often use the video output jacks of digital cameras to connect to large external display screens to replace the internal display screen, to obtain real-time image and to solve the precision issues of high-resolution photo shooting. However, conventional external display screens are either connected to cameras via a hot shoe connection or as a completely external device having no solid connection with the shooting camera, making it inconvenient for transportation and shooting.

Conventional integrated digital camera display screens are limited by their means for physical integration with the digital camera and are inconvenient for shooting photos from multiple angles. The integrated display screens also are limited by the inability of the digital camera to provide sufficient display for high-resolution photos. Furthermore, the existing external display screens require physical connections that are inconvenient for transportation and shooting.

Thus, there is a recognized need in the art for improved display screens for digital cameras that both are easy to view and are adapted for variable positioning while electronically linked with the digital camera. Particularly, the prior art is deficient in a rotatable image display screen with a camera support frame to electronically link to and to support a digital camera for handheld use or mounted on a tripod. The present invention fulfills this longstanding need and desire in the art.

### SUMMARY OF THE INVENTION

In one embodiment, the present invention is directed to an image display apparatus for a digital camera. The image display apparatus comprises a rotatable image display screen external to the digital camera and a stabilizing frame effective to secure and stabilize the digital camera thereon. The rotatable image display screen is rotatably hinged to the stabilizing frame. The present invention is directed to a related image display apparatus further comprising a slidable removable cover to shield signal conducting wires from the digital camera to at least the rotatable image display screen.

The present invention also is directed to an image display system for a digital camera. The image display system comprises the image display apparatus described herein and a digital camera engaged to the camera engagement portion of the stabilizing frame of the image display apparatus. The present invention is directed to a related image display system further comprising a tripod threadably engaged with the threaded engagement point on the camera engagement portion of the stabilizing frame.

The present invention is directed further to an image display apparatus in combination with a digital camera. The combination of the apparatus and digital camera comprises a rotatable image display screen externally hinged to a camera stabilizing frame and a digital camera threadably engaged with the camera stabilizing frame and electronically connected to the rotatable image display screen. A battery compartment is formed in the camera stabilizing frame and is configured to contact a battery to power the image display apparatus and a slidable and removable cover is disposed in protective relationship to signal transmission cables electronically connected to the rotatable image display screen. The present invention is directed to a related image display apparatus and digital camera combination further comprises further comprises a removable battery container that slidably engages with the battery compartment.

Other and further aspects, features, and advantages of the present invention will be apparent from the following description of the presently preferred embodiments of the invention given for the purpose of disclosure.

### BRIEF DESCRIPTION OF THE DRAWINGS

So that the matter in which the above-recited features, advantages and objects of the invention, as well as others that will become clear, are attained and can be understood in detail, more particular descriptions of the invention briefly summarized above may be had by reference to certain embodiments thereof that are illustrated in the appended drawings. These drawings form a part of the specification. It is to be noted, however, that the appended drawings illustrate preferred embodiments of the invention and therefore are not to be considered limiting in their scope.

FIGS. 1A-1B are three-dimensional front (FIG. 1A) and rear (FIG. 1B) perspective assembled views of the external rotatable display screen system and digital cameras.

FIGS. 2A-2D are three-dimensional perspective views of the rotatable display screen and a stabilizing frame depicting the display screen in an unrotated and unpivoted (FIG. 2A), rotated (FIG. 2B), partially pivoted (FIG. 2C) and completely pivoted (FIG. 2D) configurations with respect to the stabilizing frame.

FIGS. 3A-3B are a bottom plan view (FIG. 3A) and a side plan view (FIG. 3B) of the camera engagement portion of the stabilizing frame.

FIGS. 4A-4B are rear perspective views of the rotatable display screen and stabilizing frame depicting the signal transmission pathways from the stabilizing frame (FIG. 4A) and the stabilizing frame with a cover to shield the signal conducting wires therein (FIG. 4B).

FIGS. 5A-5D are perspective views of a rotatable electronic connector or plug and signal transmission cable (FIGS. 5A-5B) showing engagement of the connector with a digital camera port (FIGS. 5C-5D).

FIGS. 6A-6B are a rear plan view of the stabilizing frame depicting the battery compartment and locking mechanism thereon without (FIG. 6A) or with (FIG. 6B) a battery or battery pack secured therein.

FIGS. 7A-7B are a top plan view of a battery pack as an alternate means to power the image display apparatus depicted with the cover in open (FIG. 7A) and closed (FIG. 7B) positions.

FIGS. 8A-8B are partial side and top plan views of the locking mechanism comprising a switch (FIG. 8A) and a depressible latch (FIG. 8B) controlled by the switch to lock and release a battery or battery pack in position within the battery compartment.

### DETAILED DESCRIPTION OF THE INVENTION

As used herein the specification, “a” or “an” may mean one or more. As used herein in the claim(s), when used in conjunction with the word “comprising”, the words “a” or “an” may mean one or more than one.

As used herein “another” or “other” may mean at least a second or more of the same or different claim element or components thereof. Similarly, the word “or” is intended to include “and” unless the context clearly indicates otherwise. “Comprise” means “include.”

As used herein, the term “about” refers to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value (e.g., having the same function or result). In some instances, the term “about” may include numerical values that are rounded to the nearest significant figure.

In one embodiment of the present invention, there is provided an image display apparatus for a digital camera, comprising a rotatable image display screen external to the digital camera; and a stabilizing frame effective to secure and stabilize the digital camera thereon, said rotatable image display screen rotatably hinged to the stabilizing frame. Further to this embodiment, the image display apparatus comprises a a slidable removable cover to shield signal conducting wires from the digital camera to at least the rotatable image display screen.

In both embodiments the rotatable image display screen may comprise a hinge around which the display screen pivots in a horizontal plane. Particularly, the image display screen pivots 180 degrees in the horizontal plane. Also, the rotatable image display screen comprises a swivel around which the display screen rotates in a vertical plane. In this instance the image display screen may rotate 180 degrees forward and 90 degrees rearward in the vertical plane. In addition the rotatable image display screen may comprise tabs disposed on upper and lower corner edges thereof that snap into a receiving slot on the stabilizing frame.

Furthermore, in embodiments of the present invention, the stabilizing frame has a camera stabilizing portion and an image display screen receiving portion. In these embodiments the camera stabilizing portion may comprise a first upper surface effective to engage and stabilize the digital camera thereon; a first lower surface having a threaded engagement point thereon; a second upper surface in perpendicular relationship to the first upper surface having a connector configured to electronically connect to a video port on the digital camera; and a second rear surface having a port thereon configured to electronically connect to another image display device.

In one aspect, the first upper surface may comprise a knob having a knob end and a threaded end effective to threadably engage the digital camera at a camera attachment point thereon. Also, the first upper surface may comprise one or two slots thereon and further comprises a slotted side disposed between the first upper and lower surfaces and connecting the one or two slots whereby the slots in combination may movably contain the knob therein.

In another aspect the electronic connector comprising the second upper surface may be configured to split a signal received from the camera video port between the rotatable image display screen and the other image display device. In yet another aspect, the second rear surface may have a battery compartment formed therein configured to slidably receive and connect to a battery. Further to this aspect, the camera engagement portion may comprise a removable battery container that slidably engages with the battery compartment.

In addition in both embodiments, the image display screen receiving portion is formed along a side edge of the camera stabilizing portion of the stabilizing frame and configured to receive the image display screen. Also, the image display screen receiving portion may comprise a slot positioned thereon to receive a tab disposed on the image display device. In addition the image display screen receiving portion comprises a means for supporting a rod around which the hinge pivots the image display screen in the horizontal plane.

In another embodiment of the present invention, there is provided an image display system for a digital camera, comprising the image display apparatus as described herein; and a digital camera engaged to the camera engagement portion of the stabilizing frame of the image display apparatus. Further to this embodiment, the image display system comprises a tripod threadably engaged with the threaded engagement point on the camera engagement portion of the stabilizing frame.

In yet another embodiment of the present invention, there is provided an image display apparatus in combination with a digital camera, comprising a rotatable image display screen externally hinged to a camera stabilizing frame; a digital camera threadably engaged with the camera stabilizing frame and electronically connected to the rotatable image display screen; a battery compartment formed in the camera stabilizing frame configured to contact a battery to power the image display apparatus; and a slidable and removable cover in protective relationship to signal transmission cables electronically connected to the rotatable image display screen. Further to this embodiment the image display apparatus and digital camera combination comprises a removable battery container that slidably engages with the battery compartment.

In various embodiments of the present invention, the image display screen may pivot 180 degrees horizontally and may rotate vertically 180 degrees forwardly and 90 degrees rearwardly. In addition, the stabilizing frame may comprises a first upper surface with one or two slots thereon connecting to a slotted edge disposed between the first upper surface and a first lower surface; a knob with a knob end and a threaded end movably contained within the slots such that the threaded end threadably engages a camera attachment point on the digital camera; a threaded engagement point disposed on the first lower surface; a second upper surface in perpendicular relationship to the first upper surface having a connector configured to electronically connect to a video port on the digital camera; a second rear surface having a port thereon configured to electronically connect to another image display device, where the second rear surface has a battery compartment formed therein; and an image display screen receiving portion formed along a side edge of the camera stabilizing portion of the stabilizing frame and configured to receive the image display screen.

Furthermore, in various embodiments of the present invention, the electronic connector may be configured to split a signal received from the camera video port between the rotatable image display screen and the other image display device. In addition the image display screen receiving portion may comprise a slot positioned thereon to receive a tab disposed on the image display device. Furthermore, the image screen receiving portion comprises means for supporting a rod around which the hinge pivots the image display screen in the horizontal plane.

Provided herein are apparatuses and systems comprising an external rotatable image display screen and a stabilizing frame for a digital camera. The external rotatable image display screen apparatus connects with a video output jack of a digital camera to display real-time images from the camera, thus replacing the integrated display screen of the camera. In combination with a digital camera and, optionally, a tripod, the apparatus disclosed herein enables shooting and viewing photos from multiple angles. This enhances the precision of image display to suit multiple environmental requirements of photography by expanding the display screen.

Since the external rotatable image display screen comprising the apparatus is not an integral component of the digital camera, the viewing area of the display screen can be increased significantly over that of the digital camera. For example, the display screen may be, but not limited to, about 5-6 inches. Moreover, the stabilizing frame comprises a port, for example, an HDMI port that allows the image to be viewed simultaneously on another display medium or device, such as on a computer screen or a television screen, by splitting the video signal transmitted from the digital camera between the rotatable display screen and the other display device. Thus, a real-time image from the digital camera can be displayed with a higher resolution thereby providing for an enhanced visual examination of photographic effects.

The image display apparatus enables a digital camera to be secured on a surface that substantially accommodates the footprint of the camera via the camera attachment point on the camera generally used to secure the camera to a tripod, as is known in the art. Therefore, the stabilizing frame also provides an attachment point for a tripod or other stand or mount. Moreover, the external rotatable image display screen can rotate both forward and rearward in the vertical plane. Thus the image display apparatus enables shooting and viewing photographs from multiple angles, such as shooting from beneath, from above, with an obstacle and self-portrait in real-time. When not in use the image display screen can swivel or pivot in the horizontal plane to be secured along the length of the stabilizing frame for compact storage or ease of transport.

As described below, the invention provides a number of advantages and uses, however such advantages and uses are not limited by such description. Embodiments of the present invention are better illustrated with reference to the Figure(s), however, such reference is not meant to limit the present invention in any fashion. The embodiments and variations described in detail herein are to be interpreted by the appended claims and equivalents thereof.

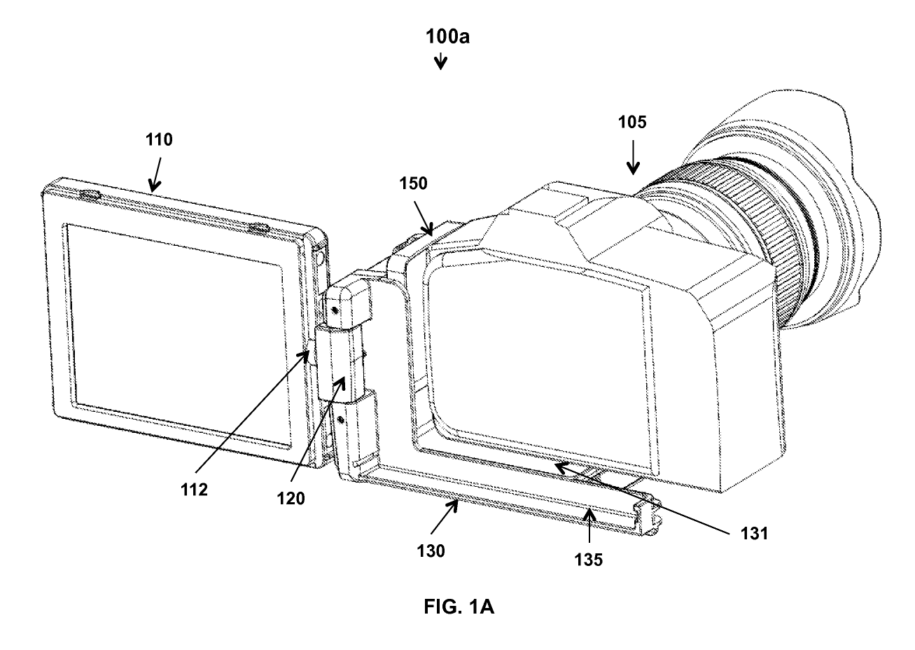

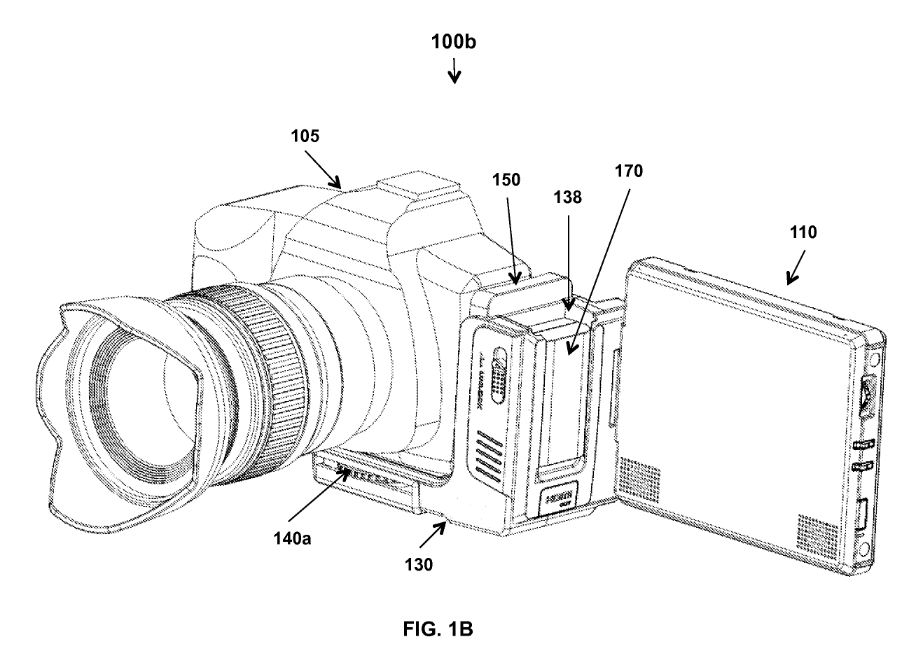

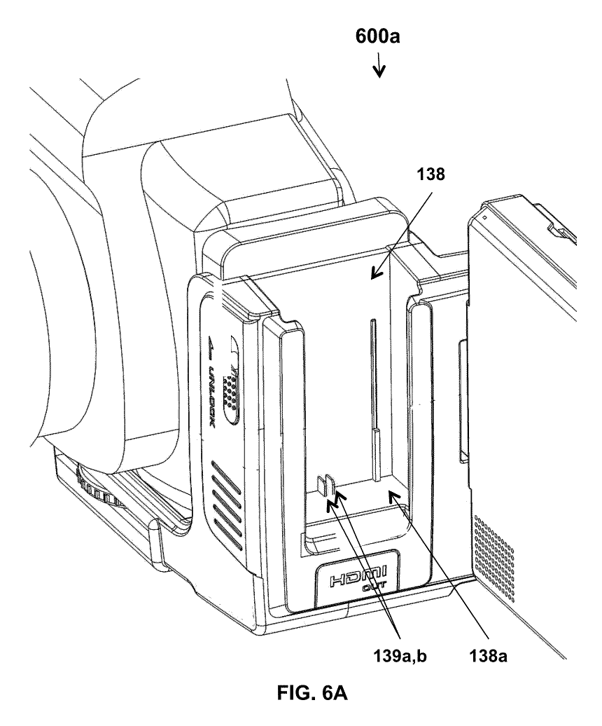

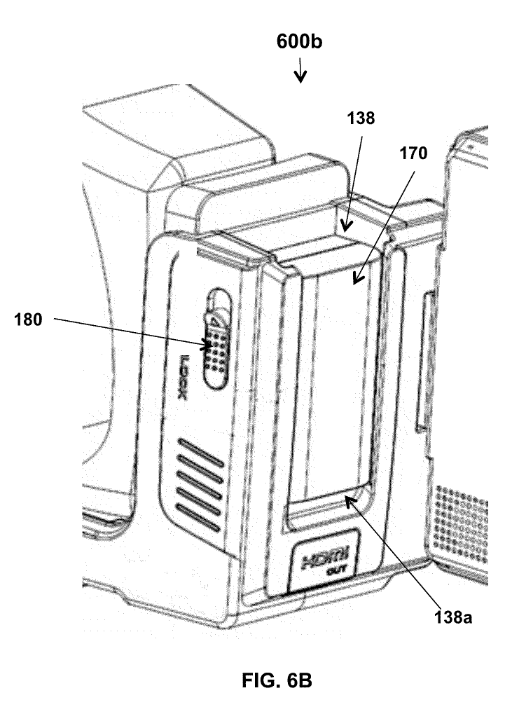

FIGS. 1A and 1B depict front 100a and rear 100b perspective views of the rotatable display screen system or image display apparatus with a digital camera engaged therewith. The display screen 110 is rotatably and pivotably connected to hinge 120 via swivel 112 to a stabilizing frame 130 adapted to secure a digital camera 105 thereto. The display screen may comprise a liquid crystal display as is well known in the art. The stabilizing frame has a camera engagement portion 131 onto which the digital camera is secured and electronically linked to the display screen, a display screen receiving portion 135 into which the display screen can pivot or swivel in the horizontal plane via hinge 120 to safely secure the display screen when not in use or when transported or stored. The swivel 112 also enables the display screen to rotate in the vertical plane for variable angled viewing. A protective cover 160 shields the electronics for signal transmission from the digital camera to the rotatable display screen. FIG. 1B depicts a battery compartment 138 (see FIG. 6B) into which a battery or battery pack 170 can be inserted or removed to power the system or image display apparatus and a threaded knob 140 disposed within the stabilizing frame with which to engage the digital camera.

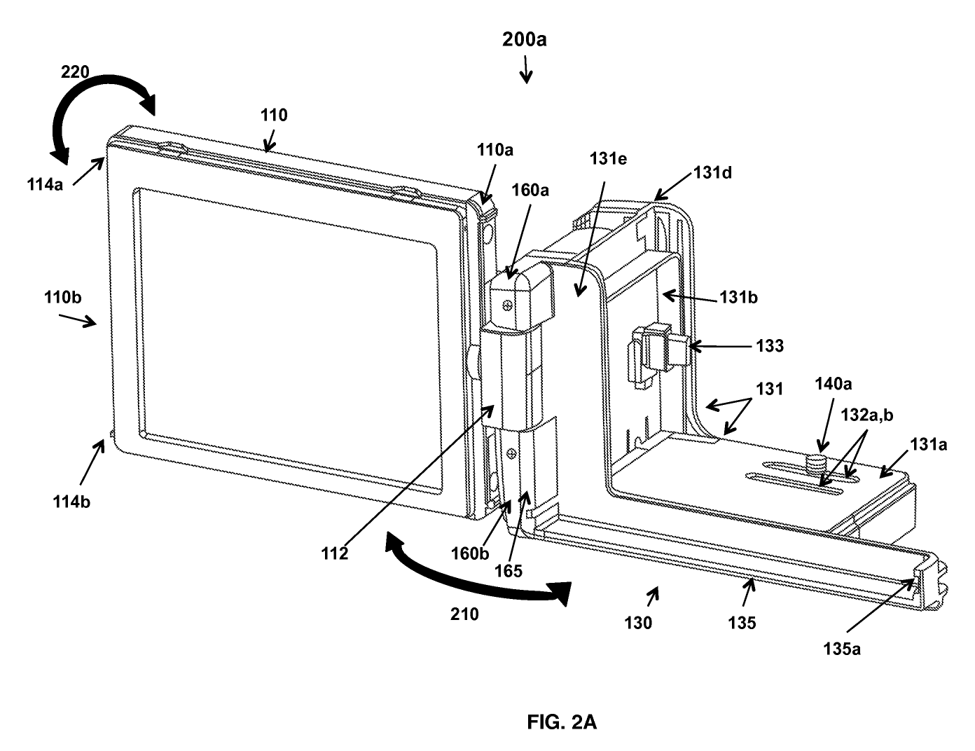

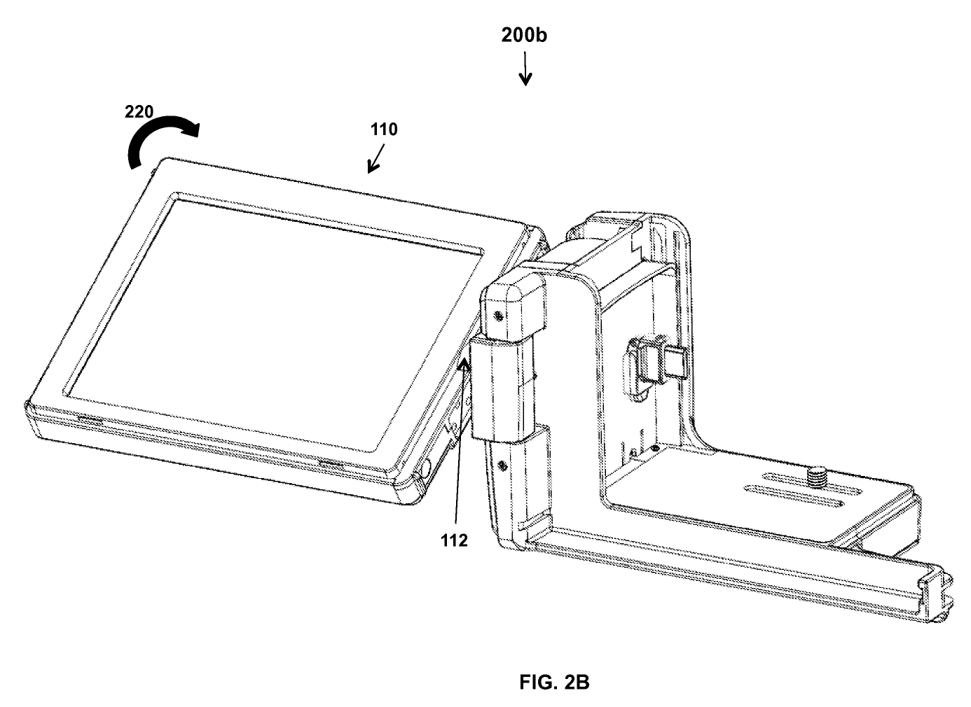

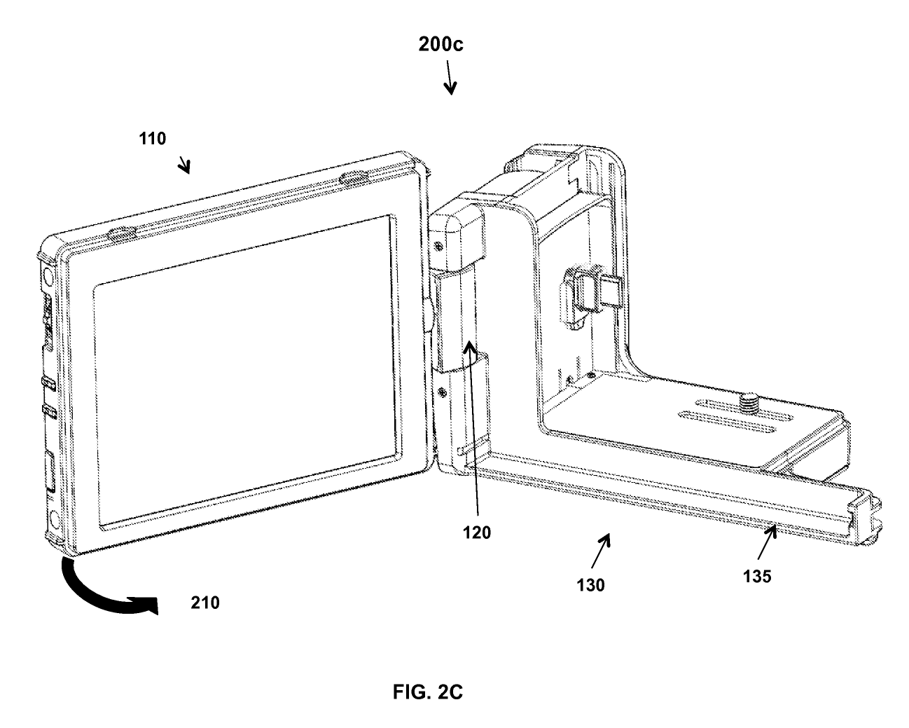

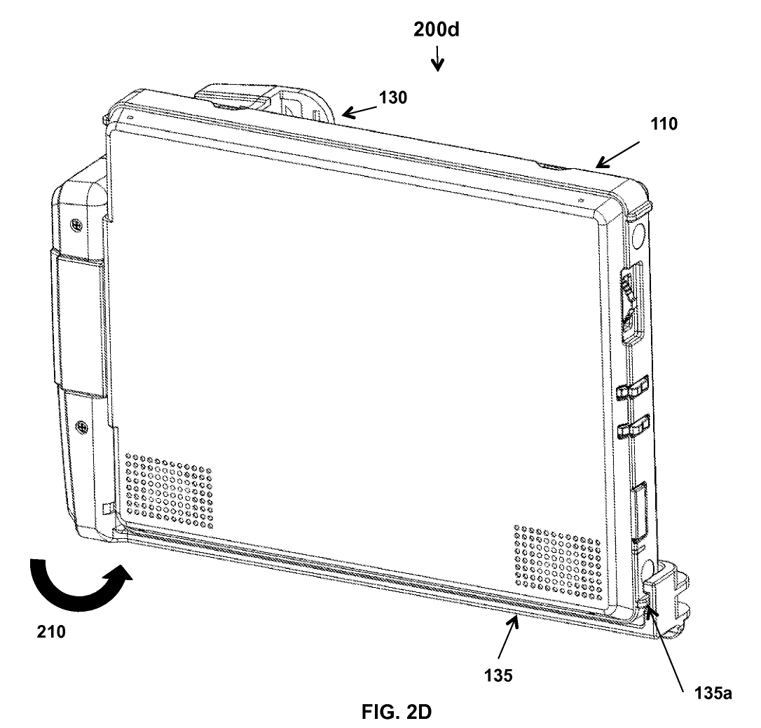

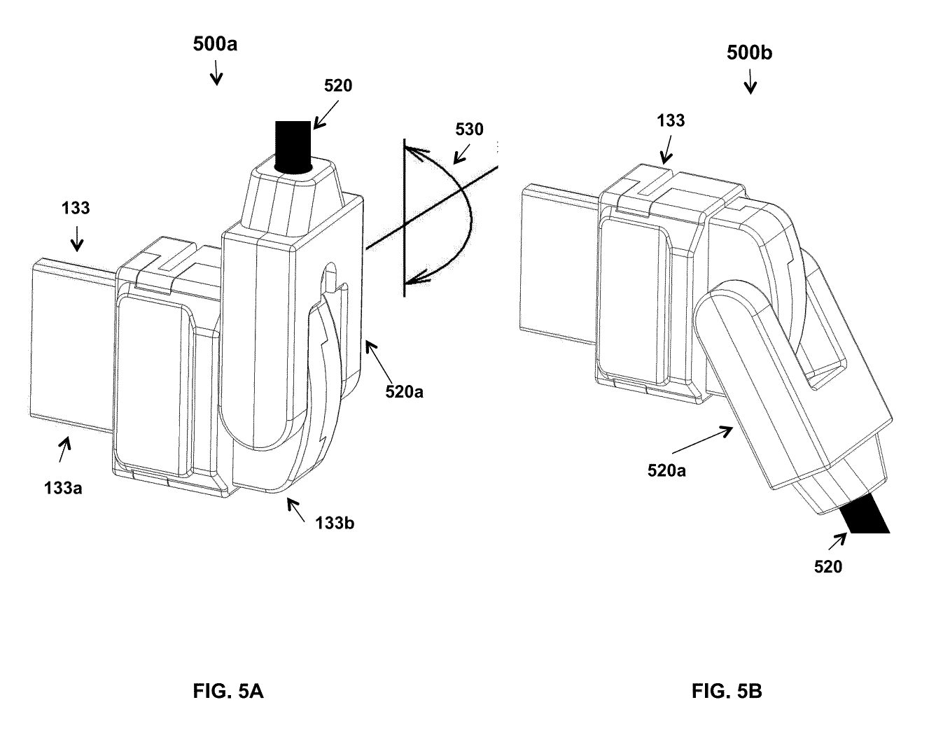

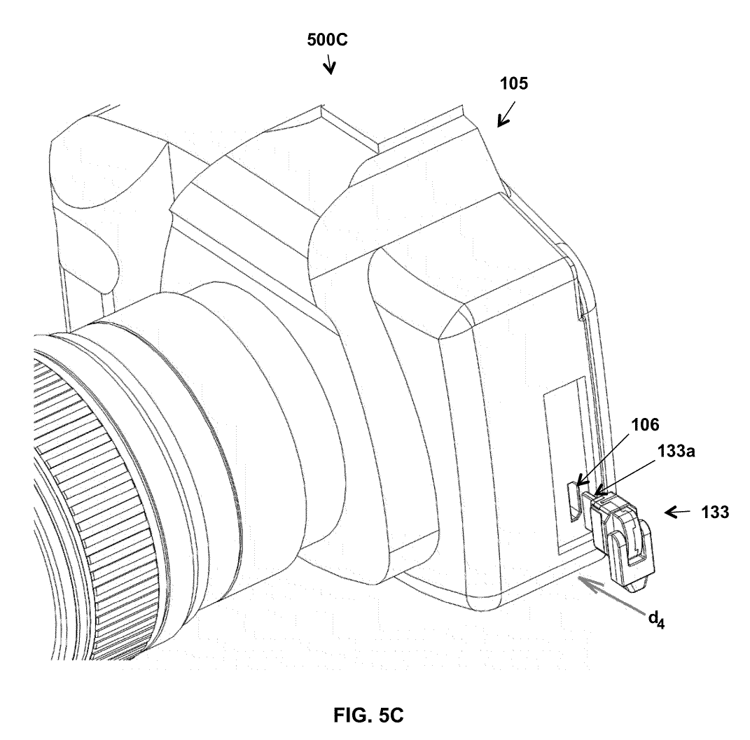

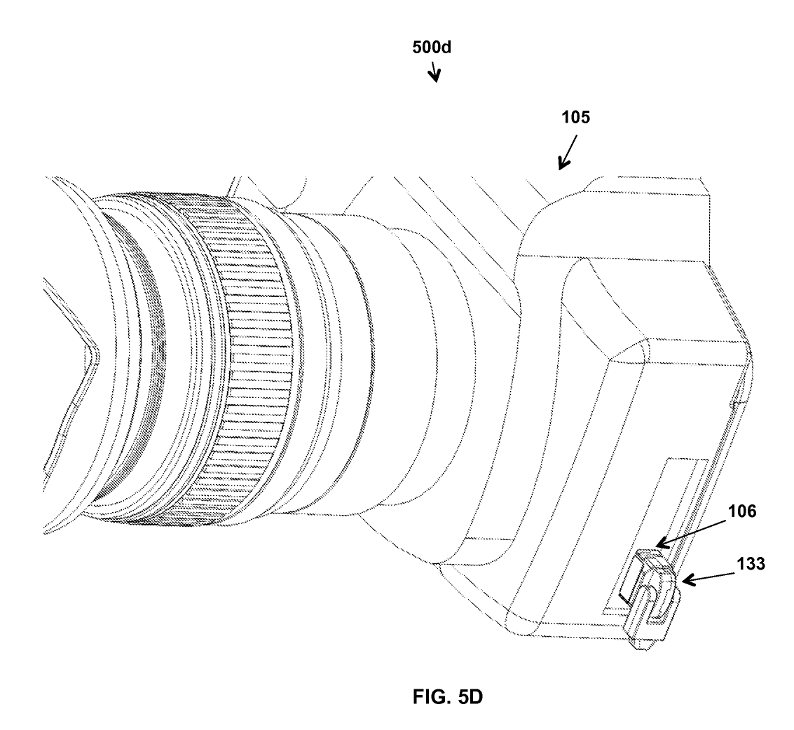

With continued reference to FIG. 1A, FIGS. 2A, 2B, 2C and 2D depict front perspective views 200a,b,c,d of the rotatable display screen and stablilizing frame. The camera engagement portion 131 of the stabilizing frame 130 comprises a first upper surface 131a with slots 132a,b and a second recessed upper surface 131b perpendicular to the first upper surface with a connector 133, for example, a mini HDMI connector, thereon. The connector may be attached directly to the surface 131b and electronically integrated with the display screen or connected to a cable electronically integrated with the display screen through the surface 131b (see FIGS. 5A-5D).

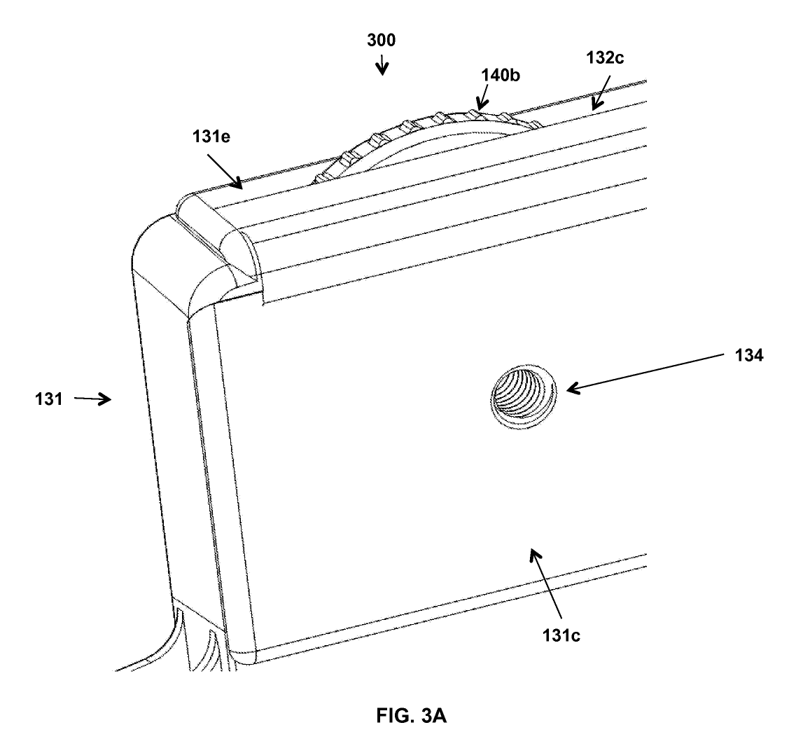

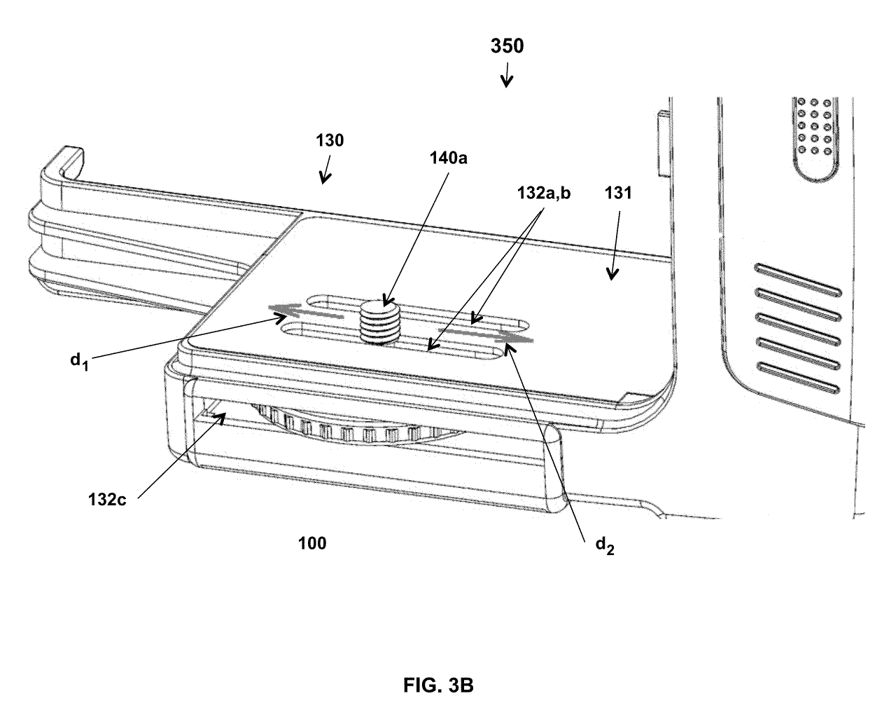

While surface 131a is depicted with two slots, other embodiments may comprise either slot 132a or 132b on the surface 131a. The connector is configured to electronically connect to the video output port of the digital camera and to transmit video signals from the digital camera to the display screen. The slots are of sufficient width to receive a threaded end 140a of the knob 140 therethrough which can threadably engage a threaded camera attachment point 134 on the bottom surface of the digital camera 105 (see FIGS. 3A-3B). Moreover, the slots have a length along which the knob may slide to line up with camera attachment point after the camera is positioned on the surface 131a and securely engages the connector on surface 131b. As is standard in the art, while the camera attachment point generally is designed, for example, to secure a camera to a tripod or other stand, it is well-suited to receive the threaded end of the knob and thereby secure the camera to the stabilizing frame.

The stabilizing frame has a side 131d in parallel apposition to side 131e from which the display screen receiving portion 135 is formed. The display screen receiving portion has an end with a slot 135a adapted to receive one of the tabs 114a,b disposed on the upper and lower corners of side 110b of the display screen 110. Whether tab 114a or tab 114b engages slot 135a depends on the rotational orientation of the display screen to the stabilizing frame 130. The side 131d comprises hinge cups 160a,b at its upper and lower ends. The hinge cups secure swivel rod 165 around which the hinge 120 swivels or pivots.

Particularly demonstrated in view 200a is the axis 210 along which the display screen 110 can pivot or swivel in the horizontal plane via hinge 120 into the display screen receiving portion 135 of the stabilizing frame 130 and the axis 220 around which the display screen can variably rotate in the vertical plane at swivel 112 connected to side 110a of the display screen. Specifically, the rotatable display screen can rotate around the swivel through a 270 degree arc and can swivel or pivot 180 degrees. FIG. 2B depicts the position of the display screen 110 after rotating about 45 degrees around axis 220 in the vertical plane around swivel 112. FIG. 2C depicts the position of the display screen 110 after pivoting about 45 degrees around axis 210 in the horizontal plane toward the screen receiving portion 135 of the stabilizing frame 130 via hinge 120 and rod 165. FIG. 2D depicts the position of the display screen 110 after pivoting 180 degrees around axis 210 in the horizontal plane and secured at 135a in the screen receiving portion 135 of the stabilizing frame 130.

FIGS. 3A and 3B are partial bottom plan 300 and side plan 350 views of the camera engagement portion of the stabilizing frame. The camera engagement portion 131 also has a first lower surface 131c and a side 131e perpendicular to the first upper 131a and first lower 131c surfaces. The lower surface 131c comprises a threaded attachment point 134 which can threadably engage a corresponding threaded attachment means on a tripod or other stand. Side 131e of the camera engagement portion has a slot 132c which connects with slots 132a,b and is at least of equal length and accommodates the knob end 140b of the threaded know 140.

FIG. 3B shows the disposition of the threaded knob 140 within slots 132a,b.c on the camera engagement portion 131 of the stabilizing frame 130 and how the threaded end 140a and knob end 140b of knob 140 are positioned within the slots. The configuration of slots 132a,b,c enables disposition of the threaded knob 140 therein such that the threaded end 140a of the knob protrudes through one of the slots 132a or 132b to threadably engage the camera attachment point on the digital camera and the knob end 140b to protrude from slot 132c to enable a user to thread the threaded end into the attachment point. Also, the protruding knob end enables a user to slide the threaded end along the slot in either direction d1 or d2 to line up with the camera attachment point.

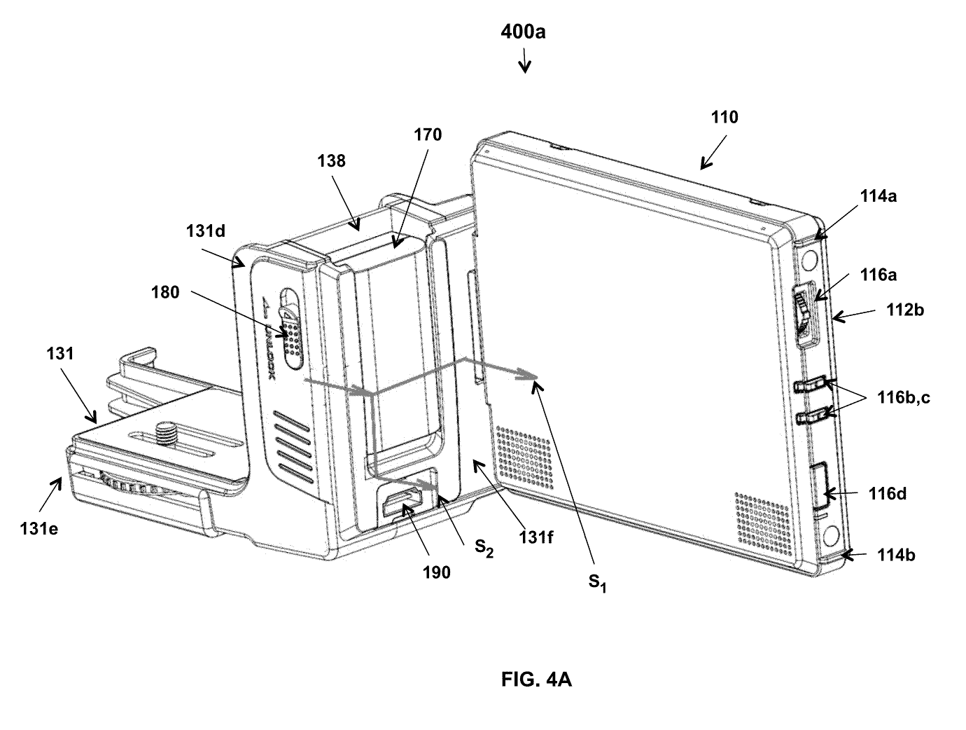

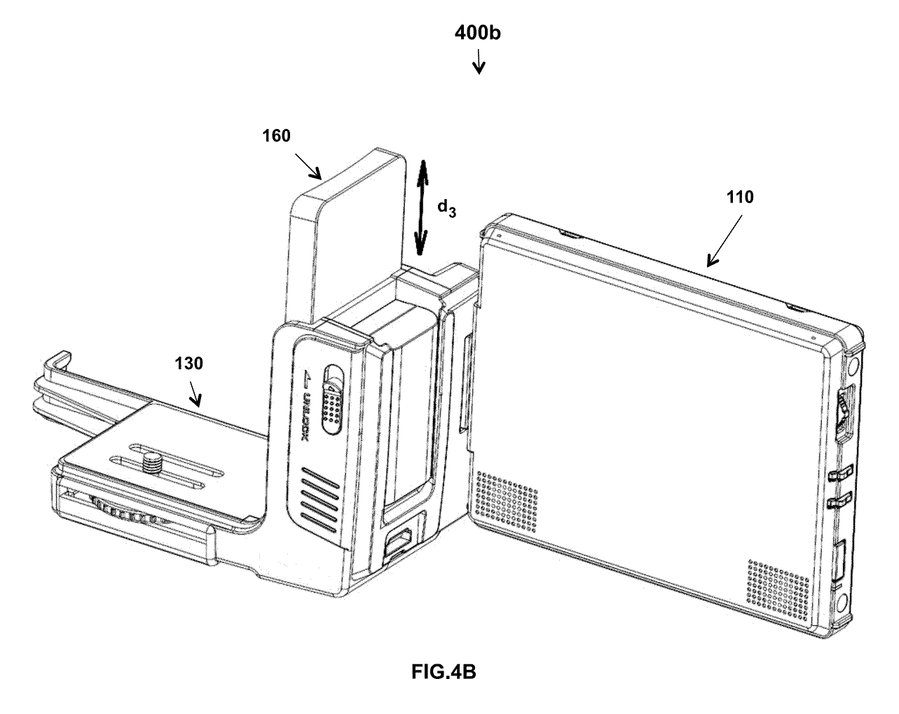

With continued reference to FIGS. 2A and 2B, FIGS. 4A and 4B depict rear perspective views 400a,b of the rotatable display screen and stablilizing frame. In FIG. 4A, the camera attachment portion 131 comprises sides 131d and 131e in perpendicular disposition and rear surface 131f. A battery compartment 138 is formed between the back of surface 131b and rear surface 131f to slidably receive a removable and replaceable battery 170. The bottom of the battery compartment comprises terminals 139a,b that mate with corresponding terminals on the battery 170 to provide power for the image display apparatus. A locking switch 180 to lock the battery to the stabilizing frame 130 when positioned inside the battery compartment is located on side 131d. Further to FIG. 2B, one can better envision the disposition of tabs 114a,b on side 112b.

A port 190, for example, an HMDI port, is located at the bottom of rear surface 131f to receive a compatible connector from another external display device, such as, but not limited to, a computer screen or other display monitor. As such, the system is configured to split the video signal from the digital camera into signals S1 and S2. Signal S1 is routed to the rotatable display screen 110 and signal S2 is routed to the other external display device accessed via the port 190. Controls 116a,b,c,d, as are known and standard in the art, are electronically connected to the display screen along side 112b.

FIG. 4B depicts a rear perspective view 400b of the rotatable display screen 110 and stabilizing frame 130 that shows a protective cover 160. The protective cover is slidable into and removable from the recess formed by the second upper surface 131b along direction d3. The protective cover shields the connector 133 or cables or other wires comprising the connector or other electronic means electronically connected to the rotatable image display screen 110 (see FIG. 2A).

With continued reference to FIG. 2A, FIGS. 5A, 5B, 5C, and 5D depict perspective views 500a,b of the electronic connector, as comprising a cable, connecting and partial perspective views 550c,d of the electronic connector with cable connected to the digital camera. In FIGS. 5A and 5B, the electronic connector has a first plug end 133a configured to engage the video port and a second connection end 133b attached to a cable end 520a of a signal transmission cable 520. The cable end can rotate 180 degrees downwardly or upwardly around the connection end of the electronic connector or plug in the vertical plane along axis 530. The hinged cable end provides flexibility so that a user may easily engage the video port of the digital camera with the electronic connector or plug. FIG. 5B depicts the cable end 520a after rotating about 135 degrees downwardly along axis 530. FIG. 5C depicts a partial view of a digital camera having a video port 106, as is known and standard in the art. The electronic connector or plug 133 is shown lined up to easily insert plug end 133a into the port 106 along d4. In FIG. 5D, the plug end 133a is plugged into the video port 106. As described in FIGS. 2A and 4B, after the digital camera is connected to the electronic connector or plug, the signal transmission cable 520 may be covered by protective cover 160.

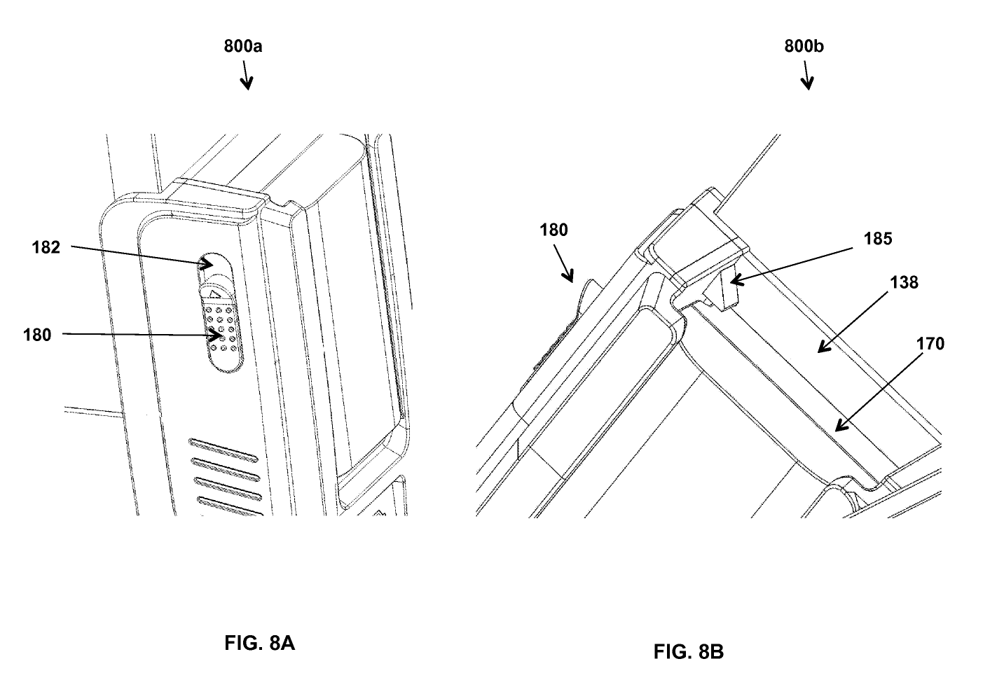

FIGS. 6A and 6B are partial rear plan views 600a,b of the stabilizing frame showing the battery compartment with and without a battery or battery pack inserted therein. FIG. 6A depicts the battery compartment 138 without a battery. The battery compartment is configured to slidably receive a battery or battery pack 170 to power the image display apparatus. The lower end 138a of the battery compartment comprises terminals 139a,b with which to engage corresponding terminals on the battery or battery pack. FIG. 6B depicts the battery compartment 138 with a battery or battery pack 170 inserted therein and positioned on the lower end 138a to engage terminals 139a,b. The battery or battery pack will automatically be secured in the battery compartment upon placement (see FIGS. 8A-8B) and may be released by moving locking switch 180 upwardly to the unlocked positioned.

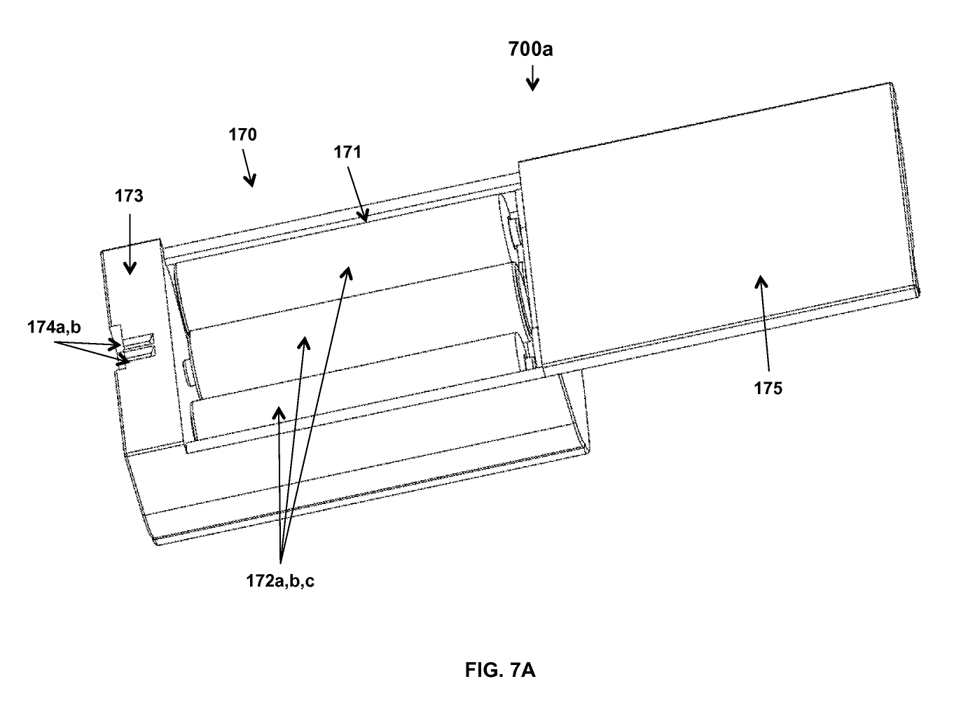

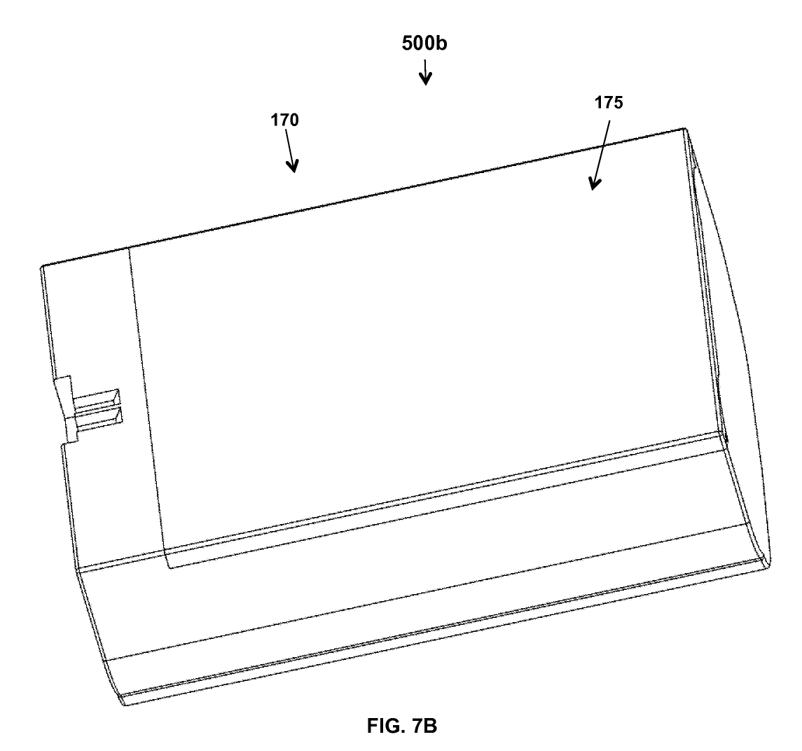

With continued reference to FIGS. 2A and 4A, FIGS. 7A and 7B depict views 700a,b of an alternate means to power the image display apparatus. In FIG. 7A a battery pack 170 has a battery containment compartment 171 of sufficient dimensions to contain three standard AAA batteries 172a,b,c and a base 173. The base comprises terminals 174a,b configured to mate or connect with terminals 139a,b on the battery compartment 138. A slidable, removable lid 175 secures the batteries within the compartment 171. FIG. 7B shows the battery pack 170 with the slidable, removable lid 175 covering the batteries contained therein.

With continued reference to FIGS. 6A and 6B, FIGS. 8A and 8B are partial side and top views 800a,b depicting the locking mechanism to secure and release a battery or battery pack. In FIG. 8A locking switch 180 is configured to remain in a locked position until physically moved upwardly to an unlocked position 182 by a user. FIG. 8B shows a depressible latch 185 controlled by the locking switch 180. The latch secures a battery or battery pack 170 within the battery compartment until released by moving the locking switch to an unlocked position 182. As a battery or battery pack is slid into the battery compartment 138, the latch 185 is depressed to allow the battery or battery pack into the compartment. When the battery or battery pack is installed within the compartment and in contact with the terminals 139a,b, the latch releases and secures the battery or battery pack within the compartment and keeps the battery terminals in contact with those in the battery compartment.

One skilled in the art will appreciate readily that the present invention is well adapted to carry out the objects and obtain the ends and advantages mentioned, as well as those objects, ends and advantages inherent herein. The present examples, along with the devices described herein are presently representative of preferred embodiments, are exemplary, and are not intended as limitations on the scope of the invention. Changes therein and other uses will occur to those skilled in the art which are encompassed within the spirit of the invention as defined by the scope of the claims.

What is claimed is:

1. An image display apparatus for a digital camera, comprising:
a rotatable image display screen external to the digital camera; and
a stabilizing frame effective to secure and stabilize the digital camera thereon, said rotatable image display screen rotatably hinged to the stabilizing frame.

2. The image display apparatus of claim 1, further comprising a slidable removable cover to shield signal conducting wires from the digital camera to at least the rotatable image display screen.

3. The image display apparatus of claim 1, wherein the rotatable image display screen comprises a hinge around which the display screen pivots in a horizontal plane.

4. The image display apparatus of claim 3, wherein the image display screen pivots 180 degrees in the horizontal plane.

5. The image display apparatus of claim 1, wherein the rotatable image display screen comprises a swivel around which the display screen rotates in a vertical plane.

6. The image display apparatus of claim 5, wherein the image display screen rotates 180 degrees forward and 90 degrees rearward in the vertical plane.

7. The image display apparatus of claim 1, wherein the rotatable image display screen comprises tabs disposed on upper and lower corner edges thereof that snap into a receiving slot on the stabilizing frame.

8. The image display apparatus of claim 1, wherein the stabilizing frame has a camera stabilizing portion and an image display screen receiving portion.

9. The image display apparatus of claim 8, wherein the camera stabilizing portion comprises:
a first upper surface effective to engage and stabilize the digital camera thereon;
a first lower surface having a threaded engagement point thereon;
a second upper surface in perpendicular relationship to the first upper surface having a connector configured to electronically connect to a video port on the digital camera; and
a second rear surface having a port thereon configured to electronically connect to another image display device.

10. The image display apparatus of claim 9, wherein the first upper surface comprises a knob having a knob end and a threaded end effective to threadably engage the digital camera at a camera attachment point thereon

11. The image display apparatus of claim 9, wherein the first upper surface comprises one or two slots thereon, further comprising a slotted side disposed between the first upper and lower surfaces and connecting the one or two slots, said slots in combination movably containing the knob therein.

12. The image display apparatus of claim 9, wherein the electronic connector is configured to split a signal received from the camera video port between the rotatable image display screen and the other image display device.

13. The image display apparatus of claim 9, wherein the second rear surface has a battery compartment formed therein configured to slidably receive and connect to a battery.

14. The image display apparatus of claim 13, further comprising a removable battery container that slidably engages with the battery compartment.

15. The image display apparatus of claim 8, wherein the image display screen receiving portion is formed along a side edge of the camera stabilizing portion of the stabilizing frame and configured to receive the image display screen.

16. The image display apparatus of claim 8, wherein the image display screen receiving portion comprises a slot positioned thereon to receive a tab disposed on the image display device.

17. The image display apparatus of claim 8, wherein the image display screen receiving portion comprises means for supporting a rod around which the hinge pivots the image display screen in the horizontal plane.

18. An image display system for a digital camera, comprising:
the image display apparatus of claim 1; and
a digital camera engaged to the camera engagement portion of the stabilizing frame of the image display apparatus.

19. The image display system of claim 18, further comprising:
a tripod threadably engaged with the threaded engagement point on the camera engagement portion of the stabilizing frame.

20. An image display apparatus in combination with a digital camera, comprising:
a rotatable image display screen externally hinged to a camera stabilizing frame;
a digital camera threadably engaged with the camera stabilizing frame and electronically connected to the rotatable image display screen;
a battery compartment formed in the camera stabilizing frame configured to contact a battery to power the image display apparatus; and
a slidable and removable cover in protective relationship to signal transmission cables electronically connected to the rotatable image display screen.

21. The image display apparatus and digital camera combination of claim 20, further comprising a removable battery container that slidably engages with the battery compartment.

22. The image display apparatus and digital camera combination of claim 20, wherein the image display screen pivots 180 degrees horizontally and rotates vertically 180 degrees forwardly and 90 degrees rearwardly.

23. The image display apparatus and digital camera combination of claim 20, wherein the stabilizing frame comprises:
a first upper surface with one or two slots thereon connecting to a slotted edge disposed between the first upper surface and a first lower surface;
a knob with a knob end and a threaded end movably contained within the slots such that the threaded end threadably engages a camera attachment point on the digital camera;
a threaded engagement point disposed on the first lower surface;
a second upper surface in perpendicular relationship to the first upper surface having a connector configured to electronically connect to a video port on the digital camera;
a second rear surface having a port thereon configured to electronically connect to another image display device, said second rear surface having a battery compartment formed therein; and
an image display screen receiving portion formed along a side edge of the camera stabilizing portion of the stabilizing frame and configured to receive the image display screen.

24. The image display apparatus and digital camera combination of claim 22, wherein the electronic connector is configured to split a signal received from the camera video port between the rotatable image display screen and the other image display device.

25. The image display apparatus and digital camera combination of claim 22, wherein the image display screen receiving portion comprises a slot positioned thereon to receive a tab disposed on the image display device.

26. The image display apparatus and digital camera combination of claim 22, wherein the image screen receiving portion comprises means for supporting a rod around which the hinge pivots the image display screen in the horizontal plane.
